(19) United States
(12) Patent Application Publication
(10) Pub. No.: US 2008/0187291 A1
(43) Pub. Date: Aug. 7, 2008

(54) Prioritization for video acquisition

(75) Inventors: Joshua Gustafson, Bothell, WA (US); Zach Johnson, Woodinville, WA (US); Mark Schwesinger, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/702,343

(22) Filed: Feb. 5, 2007

(51) Int. Cl. H04N 7/26

(52) U.S. Cl. 386/124

(57) ABSTRACT

Described herein is technology for, among other things, prioritizing video acquisition. The video acquisition may be prioritized implicitly, explicitly or a combination of both. Implicit prioritization involves receiving a request to acquire a video program. An attribute of the program is then analyzed to determine its value. The acquisition prioritization is then set based on this value. With explicit prioritization, the user is allowed to manually set the acquisition prioritization. In either case, future programs are then acquired based on the acquisition prioritization.

### BACKGROUND

In recent years, the number of personal video recorders (PVRs), such as set-top digital video recorders (DVRs) and media center computers, in homes has increased considerably. Generally speaking, a conventional PVR is a device that records video without a videotape to digital storage media. This makes the “timeshifting” feature (more traditionally done by a VCR) much more convenient, and also allows for other features such as pausing live TV, instant replay of interesting scenes, chasing playback where a recording can be viewed before it has been completed, skipping scenes/advertising, and the like.

Conventionally, PVR's have been used to record and timeshift video content received from a single source, such as analog cable, digital cable, a digital terrestrial signal, and the like. However, there is currently a shift in the television space as the technology moves more toward digital programming, high definition, on-demand content, and web downloads. With this transition, there are often multiple versions of the same program provided to the user by the broadcaster or other parties. Each version offered may have benefits and trade-offs. Depending on the programming and the intended use, the user may prefer one version over the other, or the user may be indifferent.

The quality of the video content (e.g., resolution) is one major differentiator between program offerings. Oftentimes there are high definition (HD) and standard definition (SD) broadcasts of the same show on TV. In addition, Web downloads or Web streams may also be available at these or other quality levels (possibly lower than SD due to file size and bandwidth constraints). Quality generally has a direct impact on the size of the file and can also have an impact on what television devices are capable of playing back the file, so it is not obvious that users may always want the highest quality version available.

The source of the video content is another growing differentiator and can carry along with it a number of additional attributes which are important to the user. For example, the user may have a full subscription to one source and another might require payment. Moreover, digital rights between the sources may be different. For example, the user might only be able to use one particular source with certain devices.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Described herein is technology for, among other things, prioritizing video acquisition. The video acquisition may be prioritized implicitly, explicitly or a combination of both. Implicit prioritization involves receiving a request to acquire a video program. An attribute of the program is then analyzed to determine its value. The acquisition prioritization is then set based on this value. With explicit prioritization, the user is allowed to manually set the acquisition prioritization. In either case, future programs are then acquired based on the acquisition prioritization.

Thus, embodiments provide technology for prioritization of video acquisition based on one or more attributes of the content. Embodiments allow for implicit and explicit determinations of priority. Moreover, embodiments also allow the ability to adapt as technology continues to change. For example, if a new resolution standard in the superior to HD is established down the road, a simple rolling update (e.g., via the Internet) can add this new resolution to the list of possible values for the resolution attribute.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a block diagram of an exemplary computing system environment for implementing embodiments.

FIG. 2 illustrates a block diagram of a system for prioritizing video acquisition, in accordance with various embodiments.

FIG. 3 illustrates a flowchart of a method for implicit prioritization of video acquisition, in accordance with various embodiments.

FIG. 4 illustrates a flowchart of a method of acquiring future programs based on an acquisition prioritization, in accordance with various embodiments.

FIG. 5 illustrates a flowchart of a method for explicit prioritization of video acquisition, in accordance with various embodiments.

FIG. 6 illustrates a flowchart of a method of acquiring future programs based on an acquisition prioritization that includes a ranked list, in accordance with various embodiments.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the claims. Furthermore, in the detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions that follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking”or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

### Overview

Described herein is technology for, among other things, prioritizing video acquisition. The video acquisition may be prioritized implicitly, explicitly or a combination of both. Implicit prioritization involves receiving a request to acquire a video program. An attribute of the program is then analyzed to determine its value. The acquisition prioritization is then set based on this value. With explicit prioritization, the user is allowed to manually set the acquisition prioritization. In either case, future programs are then acquired based on the acquisition prioritization.

The following discussion will begin with a description of an example operating environment for various embodiments. Discussion will proceed to a description of the structure of a video acquisition prioritization system 200. Discussion will then proceed to descriptions of implementation of example methods for prioritizing video acquisition.

### Example Operating Environment

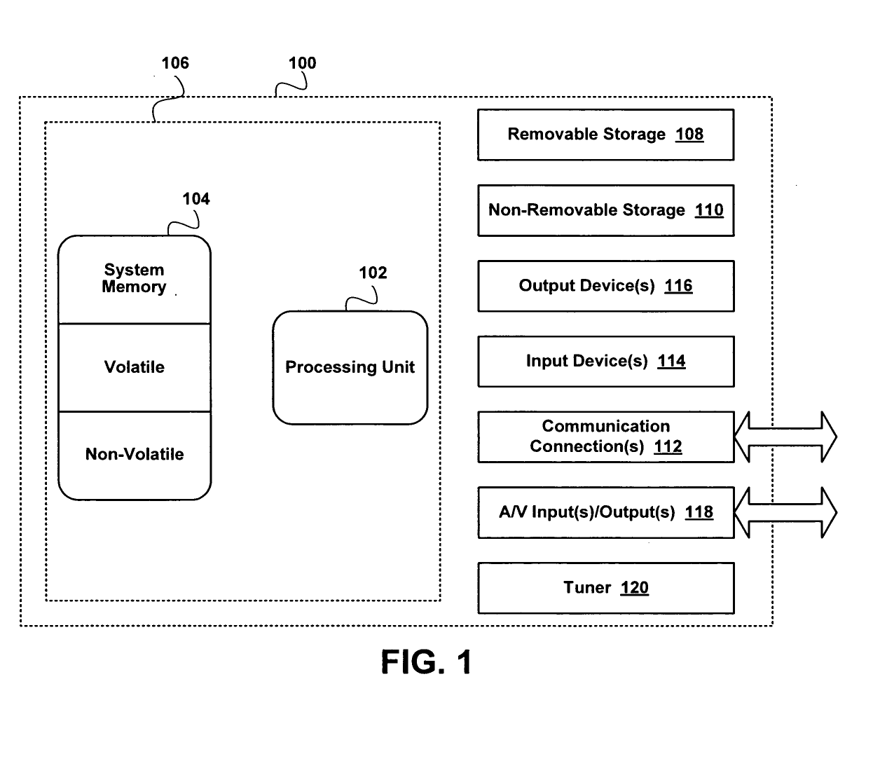

With reference to FIG. 1, an exemplary system for implementing embodiments includes a general purpose computing system environment, such as computing system environment 100. In various embodiments, the computing system environment 100 may be a personal video recorder (PVR) such as a standalone PVR, a PVR integrated into a set-top box, a media center computer, and the like. In its most basic configuration, computing system environment 100 typically includes at least one processing unit 102 and memory 104. Depending on the exact configuration and type of computing system environment, memory 104 may be volatile (such as RAM), non-volatile (such as ROM, flash memory, etc.) or some combination of the two. This most basic configuration is illustrated in FIG. 1 by dashed line 106. Additionally, computing system environment 100 may also have additional features/functionality. For example, computing system environment 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and nonremovable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 100. Any such computer storage media may be part of computing system environment 100.

Computing system environment 100 may also contain communications connection(s) 112 that allow it to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. Computing system environment 100 may also have input device(s) 114 such as a keyboard, mouse, pen, voice input device, touch input device, remote control input device, etc. Output device(s) 116 such as a display, speakers, printer, etc. may also be included. All these devices are well known in the art and need not be discussed at length here.

The computing system environment 100 may also include a number of audio/video inputs and outputs 118 for receiving and transmitting video content. These inputs and outputs may include, but are not limited to, coaxial, composite video, S-video, HDMI, DVI, VGA, component, optical, and the like. It should be appreciated that since video content may be delivered over an Internet connection, a network interface may therefore also be considered an A/V input on which video content is received. In addition, the computing system environment 100 may also include a tuner 120 for selecting specific channels for receiving video content. The tuner 120 may be coupleable with a cable card (not shown) in order to enable the tuning of certain digital channels.

Embodiments are described in terms of these example environments. Description in these terms is provided for convenience only. It is not intended that the embodiments be limited to application in this example environment. In fact, after reading the following description, it will become apparent to a person skilled in the relevant art how to implement alternative embodiments.

### Example Video Acquistion System

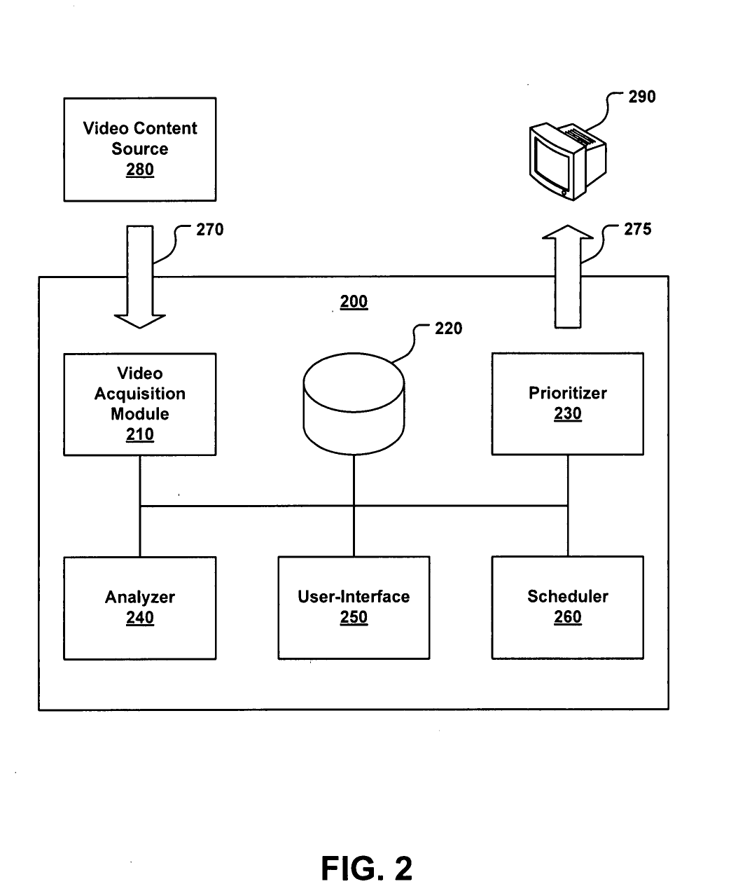

FIG. 2 illustrates a block diagram of a system 200 for prioritizing video acquisition, in accordance with various embodiments of the present invention. Video acquisition may include recording of a video program from a conventional source 280 such as cable TV, satellite TV, and the like. The acquisition may also include downloading a video program from an Internet based video content source 280.

System 200 includes one or more inputs 270 for receiving video content from a video content source 280. Since the video content source 280 may be an Internet based content source, it should be appreciated that in addition to conventional audio/video inputs, the inputs 270 may also include a network interface.

In one embodiment, system 200 includes a scheduler 260 that is operable to receive requests for scheduling the acquisition of a video program. These requests may be received, for example, via a user interface 250 or via the Internet. The request may be to schedule the acquisition of a single video program or a series of video programs. System 200 also includes an analyzer 240 that is operable to access an attribute of the requested program and analyze the attribute to determine its value. As described herein, an attribute of a video program may be any kind of variable descriptor that is associated with the form of the program's delivery. This may include, but is not limited to the quality of the video, the source of the video, any additional costs associated with acquiring the video, Digital Rights Management (DRM) rights associated with the program, whether the program is ad-supported, and the like. The quality of the video may include several tiers of resolution, such as standard definition (SD), high-definition (HD), and the like. It is appreciated that HD may further be subdivided into 720i, 720p, 1080i, and 1080p resolutions. The video source may include, but is not limited to, broadcast, analog cable, digital cable, digital satellite, and Internet based content providers. The video source may also include cost-sensitive sources such as subscription programming, on demand programming, pay-per-view programming, premium programming, and the like. Certain DRM rights, such as whether a particular program is allowed to be synchronized to a portable device (e.g., portable media player, portable gaming device, PDA, etc.) or whether the program is allowed to be written to a DVD, may be of interest as well.

The system 200 includes a prioritizer 230 for managing prioritizations with respect to any applicable attributes. In one embodiment, the prioritizer 230 is operable to implicitly determine an acquisition prioritization for future programs with respect to a given attribute by basing the acquisition prioritization of that attribute on the value determined by the analyzer 240. For example, if the scheduler 260 receives a request for a particular program, and the analyzer 240 determines that the resolution of the requested program is HD, then the prioritizer 230 will set the acquisition prioritization for resolution such that HD content is preferred over non-HD content.

In one embodiment, the prioritizer 230 is operable to explicitly determine the acquisition prioritization. This may be achieved by presenting a user a list of possible values of a particular attribute. For example, a user may be presented with the video source choices of broadcast, cable, and an Internet content provider. The list may be presented, for example, on a display device 290 coupled to the system 200 at the output 275. The user may then manually set the acquisition prioritization (e.g., with respect to the video source) via the user interface 250. In one embodiment, the user may set a simple preference (e.g., “broadcast preferred,” “cable only,” “SD preferred,” “HD only,” etc.). In another embodiment, the user may also rank the possible values in order of preference (e.g., “1:cable; 2:broadcast; 3:web,” etc.). The user may also designate one or more values as being absolutely unwanted (e.g., “no broadcast”). In one embodiment, the user is also able to create a prioritization with respect to the attributes themselves. For example, the user may designate the resolution attribute as a higher priority criterion than a DRM attribute. Similarly, the user may prioritize whether the program is ad-supported ahead of whether the program has additional fees associated with its acquisition. For example, a user may prefer to pay an additional fee to acquire an ad-free program rather than acquiring the same program at no additional charge but with commercials. It should be appreciated that system 200 is capable of using both implicit and explicit means together to determine the acquisition prioritization.

Once the acquisition prioritization has been set by the prioritizer 230, a video acquisition module 210 is operable to acquire the requested program and other future programs in accordance with the determined acquisition prioritization. For example, and not by way of limitation, if the acquisition prioritization for resolution has been set to “HD preferred,” the video acquisition module 210 will retrieve HD versions of future programs whenever possible. If an HD version of a particular program is not available, but an SD version is available, then the SD version will be acquired instead. On the other hand, if the acquisition prioritization has been set to “HD only” or SD programming has been designated as absolutely unwanted, then an SD version of the program will not be acquired. By way of another example, a user may prefer HD content (e.g., “HD preferred”) but require that the content have permission to be synchronized to a portable device. In such a case, the video acquisition module 210 will retrieve a lower resolution but synch-able version over an HD version in which synchronization is not allowed. Similarly, if several different possible values of an attribute are prioritized in a ranked list, the video acquisition module 210 will attempt to acquire programming in the order of highest rank value to lowest. Once acquired, programs may be stored, for example on a storage device 220, such as a hard drive, flash memory, and the like.

### Example Methods of Operation

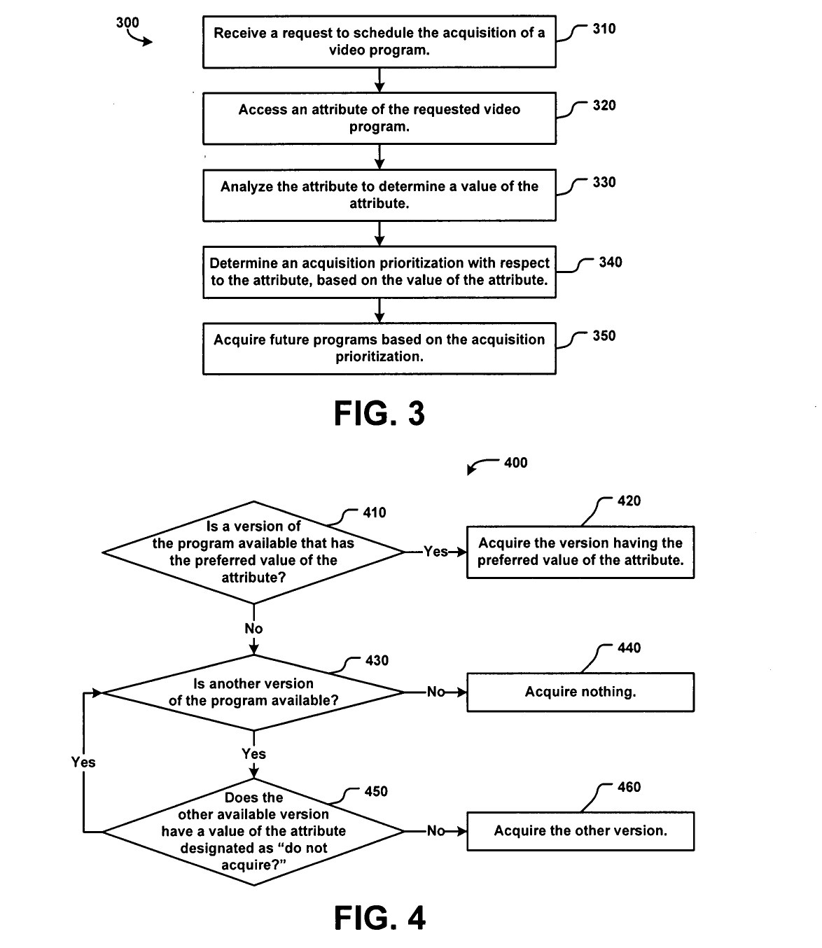

The following discussion sets forth in detail the operation of present technology for prioritization of video acquisition. With reference to FIGS. 3-6, flowcharts 300, 400 500, and 600 each illustrate example steps used by various embodiments of the present technology for prioritization of video acquisition. Flowcharts 300, 400, 500, and 600 include processes that, in various embodiments, are carried out by a processor under the control of computer-readable and computer-executable instructions. The computer-readable and computer-executable instructions reside, for example, in data storage features such as computer usable memory 104, removable storage 108, and/or non-removable storage 110 of FIG. 1. The computer-readable and computer-executable instructions are used to control or operate in conjunction with, for example, processing unit 102 of FIG. 1. Although specific steps are disclosed in flowcharts 300, 400, 500, and 600, such steps are examples. That is, embodiments are well suited to performing various other steps or variations of the steps recited in flowcharts 300, 400, 500, and 600. It is appreciated that the steps in flowcharts 300, 400, 500, and 600 may be performed in an order different than presented, and that not all of the steps in flowcharts 300, 400, 500, and 600 may be performed.

### Implicit Prioritization of Video Acquisition

FIG. 3 is a flowchart 300 of operations performed in accordance with one embodiment of the present technology for prioritization of video acquisition. More specifically, FIG. 3 illustrates a flowchart 300 of an example embodiment of a method for implicit prioritization of video acquisition.

At block 310, a request is received to schedule the acquisition of a video program. For purposes of example and not of limitation, the request may be received via a user interface 250, such as a remote control or a conventional computer input device. The request may be to schedule a single program, multiple programs, or a series of a particular program.

At block 320 an attribute of the requested video program is accessed. For the purposes of this discussion, an attribute may be one of a number of characteristics related to the delivery of the video program that may take on multiple values, as described with respect to FIG. 2 above. At block 330, the attribute is analyzed to determine the value of the attribute. Once the value of the attribute is known, and acquisition prioritization is determined with respect to that attribute, based on the value of the attribute. In one embodiment, this involves using the value of the attribute as an implicit indication of the acquisition prioritization. In other words, the value of the attribute for the requested program is assumed to be the preferred value. Thus the acquisition prioritization is adjusted accordingly to indicate the preference.

At block 350, future programs are then acquired based on the acquisition prioritization. This may be achieved in a number of ways. For example, FIG. 4 illustrates a flowchart 400 of a method of acquiring future programs based on an acquisition prioritization, in accordance with various embodiments of the present technology. At block 410, a determination is made as to whether a version of the program is available that has the preferred value of the attribute. If yes, then that version having the preferred value of the attribute is acquired (block 420). If not, then a determination is made as to whether another version of the program is available (block 430). If another version is not available, then nothing is acquired (block 440). If another version is available, then flowchart 400 proceeds to block 450, where a determination is made as to whether the other version has a value of the attribute that has been designated as “do not acquire” (i.e., whether programs having that value of the attribute are forbidden from being acquired). If not, then the other version is acquired (block 460). If yes, then process 400 returns to block 430 to look for other possible versions.

### Explicit Prioritization of Video Acquisition

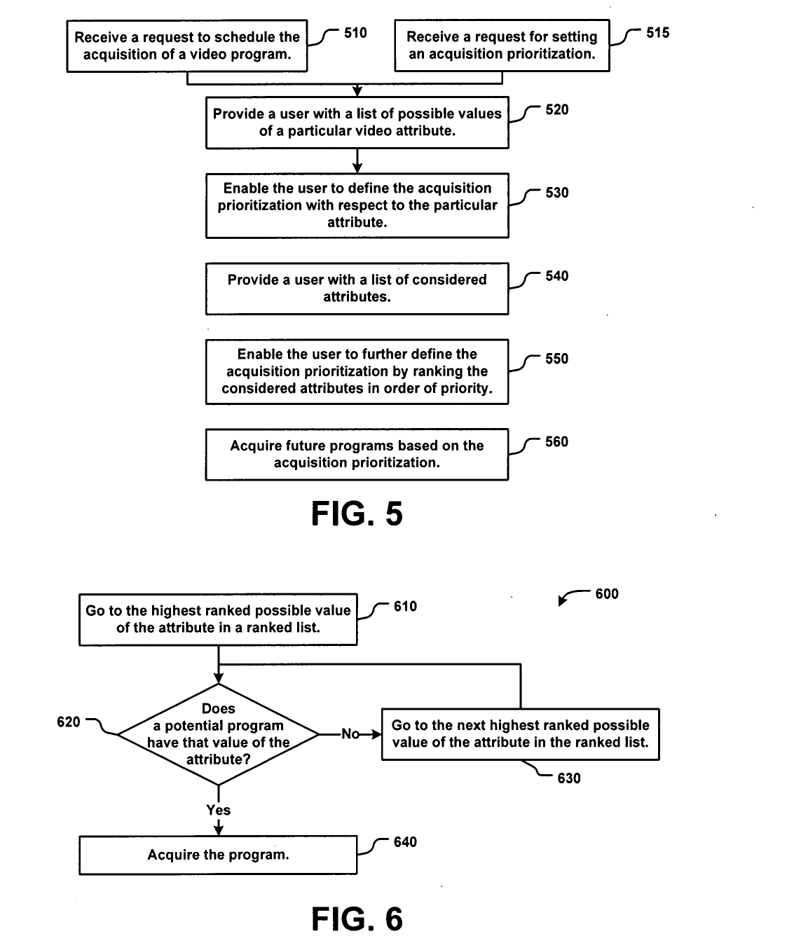

FIG. 5 is a flowchart 500 of operations performed in accordance with one embodiment of the present technology for prioritization of video acquisition. More specifically, FIG. 5 illustrates a flowchart 500 of an example embodiment of a method for explicit prioritization of video acquisition.

In one embodiment, flowchart 500 begins by receiving a request to schedule the acquisition of a video program (block 510). In another embodiment, flowchart 500 begins by receiving a request for setting an acquisition prioritization (block 515). Regardless, at block 520, a user is provided with a list of possible values of a video attribute. The list may be provided, for example, via a display device 290. Thereafter, the user is enabled to define an acquisition prioritization with respect to that attribute based on the possible values provided. It should be appreciated this may be done in a number of ways. For example, in one embodiment, this may involve enabling the user to set a simple preference (e.g., “broadcast preferred,” “cable only,” etc.). In another embodiment, this may involve enabling the user to rank the possible values in order of preference (e.g., “1:cable; 2:broadcast; 3:web,” etc.). The user may also designate one or more values as being absolutely unwanted (e.g., “no broadcast”). These prioritizations may be specific to particular programs. The prioritizations may also be defaults to be used on requests in advance of individualized settings for particular programs.

In one embodiment, the user is also able to create an acquisition prioritization with respect to the different attributes themselves. For example, at block 540, the user is provided a list of the attributes considered. At block 550, the user is then enabled to rank the various attributes in order of priority. For example, the acquisition prioritizations for resolution and source may be set to “HD preferred” and “cable preferred” respectively. Additionally, resolution may be set to a higher priority than the source. In such a case, if the only versions of a program available are an HD broadcast version and an SD cable version, the HD broadcast version will be selected over the SD cable version because resolution has been designated as a higher priority criterion than the source.

At block 560, future programs are then acquired based on the acquisition prioritization. This may be achieved a number of ways. For example, in one embodiment, if the acquisition prioritization is set to a simple preference, steps similar to those depicted in flowchart 400 (discussed in detail above) may be performed. FIG. 6 illustrates a flowchart 600 of another method of acquiring future programs based on an acquisition prioritization that includes a ranked list, in accordance with various other embodiments. At block 610, the highest ranked possible value of the attribute in the rank of list is accessed. At block 620, a determination is made as to whether a potential program has the highest ranked value of the attribute. If yes, then the program is acquired (block 640). If not, the next highest ranked attribute value is accessed from the list (block 630) and flowchart 600 returns to block 620 determine if a match is found for that attribute value. It should be appreciated that steps similar to those depicted in flowchart 600 may be performed in a recursive fashion in cases where the various attributes themselves are also ranked.

As described above with respect to FIGS. 3-6, video acquisition may be prioritized both implicitly and explicitly. Although described separately, it should be appreciated that some embodiments may include both implicit and explicit determinations of the acquisition prioritization.

Thus, embodiments provide technology for prioritization of video acquisition based on one or more video attributes. Embodiments allow for implicit and explicit determinations of priority. Moreover, embodiments also allow the ability to adapt as technology continues to change. For example, if a new resolution standard superior to HD is established down the road, a simple rolling update (e.g., via the Internet) can add this new resolution to the list of possible values for the resolution attribute.

As television as we know it continues to change, the number of sources and versions of the same content will grow. Therefore, devices utilizing this technology, such as digital video recorders and media center computers, will be able to effectively handle the scenarios surrounding prioritization between different offerings of the same program. This ability will become essential to entertainment video in the years to come.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for prioritizing video acquisition, comprising:
receiving a request to schedule the acquisition of a video program;
accessing an attribute of the requested video program;
analyzing said attribute, wherein said analyzing of said attribute determines a value of said attribute;
determining an acquisition prioritization with respect to said attribute, based on said value of said attribute; and
acquiring future programs based on said acquisition prioritization.

2. The method as recited in claim 1, wherein said attribute comprises a resolution of said video program.

3. The method as recited in claim 2, wherein said resolution is selected from the group consisting of a Standard Definition (SD) resolution and a High-Definition (HD) resolution.

4. The method as recited in claim 3, wherein said acquisition prioritization is selected from the group consisting of SD-preferred, HD-preferred, SD-only, and HD-only.

5. The method as recited in claim 2, wherein said High-Definition resolution is selected from the group consisting of 720i, 720p, 1080i, and 1080p.

6. The method as recited in claim 1, wherein said attribute comprises a source of said video program.

7. The method as recited in claim 6, wherein said source is selected from the group consisting of broadcast, analog cable, digital cable, digital satellite, and an web-based video content provider.

8. The method as recited in claim 6, wherein said source is selected from the group consisting of subscription programming, on-demand programming, pay-per-view programming, and premium programming.

9. The method as recited in claim 1, wherein said attribute comprises a Digital Rights Management indication.

10. The method as recited in claim 9, wherein said Digital Rights Management indication is selected from the group consisting of whether said video program is allowed to be synchronized to a portable device and whether said video program is allowed to be reproduced onto a DVD.

11. The method as recited in claim 9, wherein said attribute comprises an ad-supported indication.

12. The method as recited in claim 1, wherein said determination of said acquisition prioritization comprises using said value of said attribute as an implicit indication of said acquisition prioritization.

13. The method as recited in claim 1, wherein said acquisition prioritization includes a designation that future programs having a particular attribute value are not to be acquired.

14. The method as recited in claim 1, wherein said acquisition prioritization comprises a ranked list of possible values of said attribute, and wherein further said acquiring of future programs based on said acquisition prioritization comprises:
acquiring future programs having respective values of said attribute equal to the highest-ranked of said possible values, according to said ranked list; and
acquiring future programs having respective values of said attribute equal to the next-highest-ranked of said possible values, according to said ranked list, provided future programs having respective values of said attribute equal to the highest-ranked of said possible values are not available.

15. A method for prioritizing video acquisition, comprising:
providing a user with a list of possible values of a video attribute, wherein said attribute is associated with the delivery of a video program, wherein further said values comprise an assortment of manners by which video content is able to be delivered;
enabling said user to rank said possible values in order of preference to said user;
acquiring future video programs based on said user's ranking of said possible values.

16. The method as recited in claim 15 further comprising:
receiving a request from said user to acquire said video programs.

17. The method as recited in claim 15 further comprising:
receiving a request from said user to acquire a series of a particular video program; and
acquiring said series based on said request and said user's ranking of said possible values.

18. A system for prioritizing video acquisition, comprising:
one or more inputs for receiving a video program;
a scheduling portion operable to receive requests for scheduling the acquisition of said video program;
an analyzing portion operable to access an attribute of the requested program and analyze said attribute to determine a value of said attribute, wherein said attribute is associated with the delivery of said video program, and wherein further said value represents one of an assortment of manners by which video content is able to be delivered to said system;
a prioritization portion operable to determine an acquisition prioritization with respect to said attribute, based on said value of said attribute; and
an acquisition portion coupled with said one or more inputs, said acquisition portion operable to acquire future programs based on said acquisition prioritization.

19. The system as recited in claim 18 wherein said system is selected from the group consisting of a digital video recorder and a media center computer.

20. The system as recited in claim 18 further comprising:
one or more outputs for delivering video content, wherein said prioritization portion is operable to provide a user, via a display device coupled with said one or more outputs, a list of possible values of said attribute; and
a user-interface for allowing said user to manually set said acquisition prioritization by enabling said user to rank said possible values of said attribute in order of preference.
